(19) United States
(12) Patent Application Publication
(10) Pub. No.: US 2012/0274566 A1
(43) Pub. Date: Nov. 1, 2012

(54) COMPUTER WITH REMOVABLE DISPLAY MODULE FOR CONVERSION TO SLATE-TYPE COMPUTER WHILE BEING WIRELESSLY CONTROLLED BY PROCESSOR IN DETACHED KEYBOARD MODULE

(75) Inventor: Teresa Tran, San Diego, CA (US)

(73) Assignee: SONY CORPORATION

(21) Appl. No.: 13/095,152

(22) Filed: Apr. 27, 2011

(51) Int. Cl. G06F 3/02

(52) U.S. Cl. 345/168

(57) ABSTRACT

A computer includes a keyboard module bearing a key entry device and a processor in the keyboard module. The keyboard module also includes a keyboard transceiver electrically connected to the keyboard processor. The computer further includes a display module bearing a touch sensitive display which is detachably engageable with the keyboard module. A display transceiver electrically connected to the touch sensitive display wirelessly communicates with the keyboard transceiver both when the display module is mechanically engaged mechanically disengaged with the keyboard module.

### FIELD OF THE INVENTION

The present application relates generally to computers with removable display modules for conversion to slate-type computers while still being wirelessly controlled by a processor in the detached keyboard module.

### BACKGROUND OF THE INVENTION

Tablet and slate computing devices, as well as mobile computing devices such as smart phones, (hereinafter collectively “tablet computing devices”) are becoming increasingly popular in the consumer electronics market. These devices are typically controlled by an operating system which is stored and operated on the tablet computing device.

Some tablet computing devices may be electronically connected to a personal computer or a user input module such that the tablet computing device and the personal computer or input module may be controlled by a single operating system when the two are connected. However, typically data storage (which stores the operating system), at least one processor, and other necessary hardware is housed in the tablet computing device. Currently, storing an operating system and processor executing the operating system on the tablet computing device is necessary for a user to be able to access data and use the tablet computing device when the tablet computing device is not electrically connected to the user's personal computer.

Furthermore, some of the operating systems used on tablet computing devices are not easily compatible with operating systems typically operated on personal computers. For example, Google Incorporated's Android operating system for a smart phone may not be compatible when electronically connected to a personal computer operating Microsoft Corporation's Windows operating system.

The present application recognizes that storing the operating system on the tablet computing device to be executed by a processor on the tablet computing device may be disadvantageous for a plurality of reasons. Among these reasons are the unnecessary emission of thermal energy from the tablet computing device, and a relatively less adequate and reliable power supply (such as a battery) on the tablet computing device compared to, e.g., a personal computer electrically connected to a wall-mounted power supply. Additional reasons include that a processor included on the tablet computing device may increase the weight of the tablet computing device, a user must learn and use multiple operating systems, and including an operating system executable by a processor increases the purchase cost of the tablet computing device.

### SUMMARY OF THE INVENTION

With the above background in mind, the present application provides an improved tablet computing device. Accordingly, a computer includes a keyboard module that bears a key entry device. The keyboard module may have a processor capable of receiving user input signals from the key entry device. The computer may also include a keyboard transceiver in the keyboard module, where the keyboard transceiver may be electrically connected to the keyboard processor.

In addition to the keyboard module, the computer may also include a display module which may bear a touch sensitive display, where the display module may be detachably engageable with the keyboard module. The display module may also have a display transceiver that may be electrically connected to the touch sensitive display. The display transceiver may wirelessly communicate with the keyboard transceiver when the display module is physically engaged with the keyboard module, and the display transceiver may also wirelessly communicate with the keyboard transceiver when the display module is physically disengaged with the keyboard module. It is to be understood that the keyboard transceiver and display transceiver may not be wireless telephony transceivers in some embodiments.

Thus, the touch sensitive display may be controlled by the processor on the keyboard module when the display module is either engaged or disengaged with the keyboard module in non-limiting embodiments. Also in non-limiting embodiments, the processor on the keyboard module may execute a full operating system when controlling the display when the display module is physically disengaged with the keyboard module. If desired, the processor may execute a single operating system to control the touch sensitive display when the display module is physically disengaged with the keyboard module, and when the display module is physically engaged with the keyboard module. Additionally, in some non-limiting embodiments, the display module may not include a processor.

Further, in some non-limiting embodiments, the computer may include at least one male engagement element on a first one of the modules (e.g., either the keyboard module or the display module) which may be configured to releasably engage at least one female engagement element on a second one of the modules, such that a user can manually engage and disengage the modules physically with each other.

If desired, in non-limiting embodiments, the computer may also include an engagement sensor capable of inputting signals to the processor, where the processor may cause at least one transceiver to operate in a low power mode responsive to the signals indicating the display module is physically engaged with the keyboard module, and may cause at least one transceiver to operate in a higher power mode responsive to the signals indicating the display module is physically disengaged with the keyboard module.

In some non-limiting embodiments, the computer may include an engagement sensor capable of inputting signals to the processor, where the processor may respond to signals from the touch sensitive display responsive to the signals from the engagement sensor indicating the display module is physically disengaged with the keyboard module. The processor may not respond to signals from the touch sensitive display responsive to the signals from the engagement sensor indicating the display module is physically engaged with the keyboard module and only responding to signals from the key entry device.

Also, if desired, there may be a display battery in the display module to supply power to the display module, and a keyboard battery in the keyboard module to supply power to the keyboard module. Additionally, a camera may be movably mounted on the display module in non-limiting embodiments, and may send image signals through the display transceiver and keyboard transceiver to the processor.

In another aspect, a method includes establishing a wireless connection between a keyboard module of a computer and a display module of the computer, wherein the keyboard module and display module are detachably engageable with each other. The method may also include controlling a touch sensitive display on the display module using a keyboard processor on the keyboard module regardless of there being a physical connection between the keyboard module and the display module.

In still another aspect, a system includes a computer, wherein the computer may include a keyboard module bearing a key entry device and a display module bearing a touch sensitive display. The system may also include a processor in the keyboard module for receiving user input signals from the key entry device. If desired, the display module may be detachably engageable with the keyboard module.

In non-limiting embodiments, the display module and the keyboard module of the system may wirelessly communicate with each other when the display module is physically engaged with the keyboard module. If desired, the display module and keyboard module may also wirelessly communicate with each other when the display module is physically disengaged with the keyboard module. Further, in non-limiting embodiments, the touch sensitive display may be controlled by the processor on the keyboard module when the display module is either engaged or disengaged with the keyboard module.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of an example computer in accordance with present principles with the display module physically engaged with the keyboard module;

FIG. 2 is a perspective view of an example computer in accordance with present principles with the display module physically disengaged with the keyboard module;

FIG. 3 is a perspective view of the rear of the keyboard module, showing the engagement receptacles, with portions broken away for clarity;

FIG. 4 is a block diagram showing components of the display module and keyboard module; and

FIG. 5 is a flow chart showing example logic in accordance with present principles.

### DETAILED DESCRIPTION OF THE PREFERRED EMBODIMENT

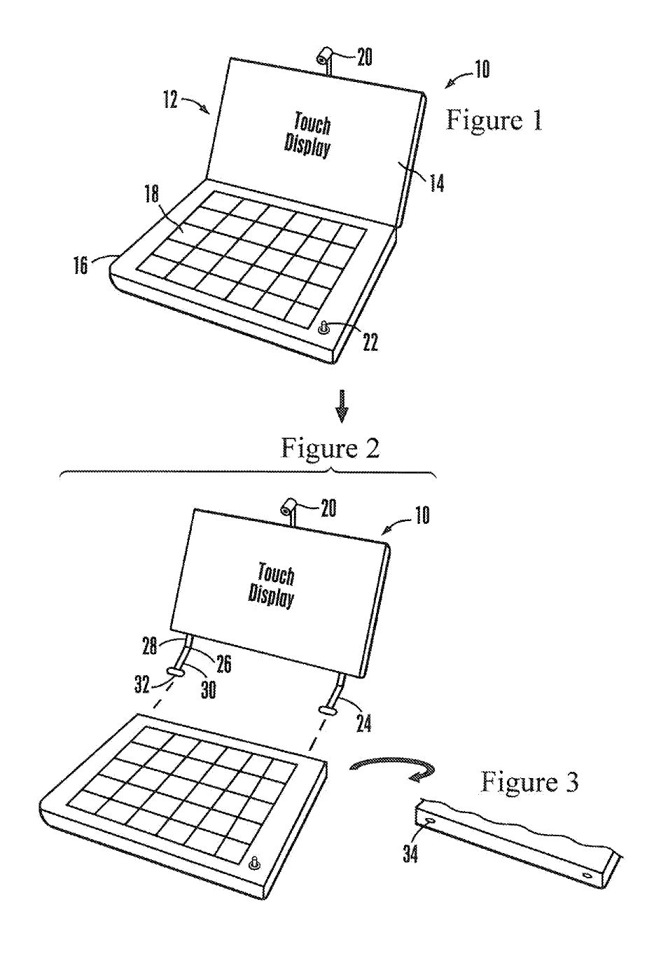

Beginning initially with FIG. 1, a perspective view of an example computer in accordance with present principles with the display module physically engaged with the keyboard module is shown. Thus, the computer 10 may include a display module 12 having a touch sensitive display 14. In non-limiting embodiments, the display module 12 may also include a camera 20 that may be movably mounted on the display module 12. The camera 20 may be, without limitation, a digital camera or a “web cam.” Further, it is to be understood that, in some embodiments, the camera 20 may be mounted within the display module 12 such that the camera 20 does not protrude from the display module 12.

The computer 10 also has a keyboard module 16 bearing a key entry device 18. The key entry device 18 may be, without limitation, a computer keyboard. A joystick 22 is also shown on the keyboard module 16, but it is to be understood that other non-limiting input devices may also be included on the keyboard module 16, such as, but not limited to, a point-and-click device such as a mouse or a touch-sensitive pad.

It is to be understood that the display module 12 may be releasably engaged with the keyboard module 16, as shown in FIG. 1. It is to be understood that a user may manually engage or disengage the display module 12 and keyboard module 16 physically from each other in accordance with present principles. The releasable engagement of the display module 12 with the keyboard module 16 can be better understood in relation to FIG. 2.

Now referencing FIG. 2, a perspective view of an example computer in accordance with present principles with the display module physically disengaged with the keyboard module is shown. As shown in FIG. 2, the computer 10 has a display module 12, the display module 12 optionally including the touch sensitive display 14 and camera 20 as described above. The display module 12 is disengaged with the keyboard module 16 having the key entry device 18 and joystick 22 described above in the perspective view shown in FIG. 2.

As shown in FIG. 2, the display module 12 may have at least one male engagement element 24 configured to releasably engage at least one female engagement element (not shown in FIG. 2) on the keyboard module 16 such that a user can manually engage and disengage the modules physically with each other. The female engagement element may be, without limitation, a receptacle capable of closely receiving the male engagement element 24. However, it is to be understood that in other non-limiting embodiments, the keyboard module 16 may have at least one male engagement element, while the display module 12 may have at least one female engagement element.

Regardless, in non-limiting embodiments, the male engagement element 24 may hinge with resistance at a joint 26 between a vertical leg 28 and a horizontal leg 30 of the a male engagement element 24. Furthermore, the horizontal leg 30 can be formed on its end with a detent 32 or other structural resistance element for an interference and/or snapping fit with the female engagement element. Thus, a user can easily engage and disengage the display module 12 from the keyboard module 16 by hand without needing any tools or other devices for assistance. It may be appreciated from FIG. 2 that the display module 12 may be manually disengaged from the keyboard module 16 in non-limiting embodiments. Further, it is to be understood that that no wired connection may exist between display module 12 and keyboard module 16 in non-limiting embodiments.

Moving on to FIG. 3, a perspective view of the rear of the keyboard module showing the engagement receptacles, with portions broken away for clarity, is shown. It may be seen from FIG. 3 that the keyboard module 16 may have at least one female engagement element 34 capable of closely receiving the at least one male engagement element 24 described above. Thus, the male engagement element 24 may be closely received by the female engagement element 34 and/or may hinge on the female engagement element 34 with resistance at a joint 26 between the vertical leg 28 and a horizontal leg 30 (described above). It may be appreciated from FIG. 3 that the horizontal leg 30, which may be formed on its end with a detent 32 in non-limiting embodiments, may be received by the female engagement element 34 for an interference or snapping fit between the male engagement element 26 and female engagement element 34 so that a user can manually engage and disengage the display module 12 from the keyboard module 16.

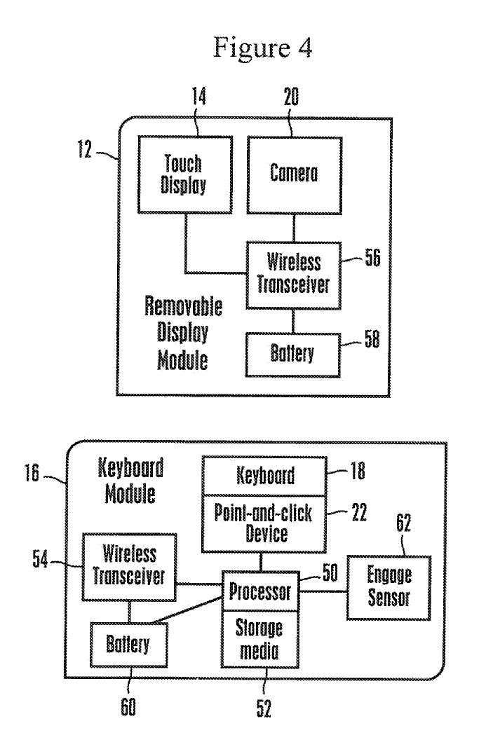

Now in reference to FIG. 4, a block diagram showing additional components of the display module and keyboard module in accordance with present principles is shown. The keyboard module 16 houses a processor 50 which receives user input signals from the key entry device 18, and which also executes logic, such as the logic described herein. The keyboard module 16 also includes a computer readable storage medium 52 in non-limiting embodiments, such as disk-based or solid state storage, and the processor accesses instructions on the medium 52 to execute logic herein.

Further, the keyboard module 16 includes a wireless transceiver 54 electrically connected to the processor 50 and wirelessly communicating with a wireless transceiver 56 on the display module 12. Additionally, the wireless transceiver 56 on the display module 12 is electrically connected to the touch sensitive display 14 in non-limiting embodiments. Further, in non-limiting embodiments, the transceivers 54, 56 are not wireless telephony transceivers. It is to be understood that, if desired, the transceivers may communicate over a private network such that any information and/or data sent between them may not be accessible to a device outside the network. Thus, the display module 12 has access to information and/or data stored on the keyboard module 16.

Still in reference to FIG. 4, the display module 12 is detachably engageable with the keyboard module 16 as described above. However, regardless of whether the display module 12 and keyboard module 16 are mechanically engaged or disengaged, the wireless transceiver 56 of the display module 12 wirelessly communicates with wireless transceiver 54 of the keyboard module 16. Thus, the display 14 is controlled by the processor 50 on the keyboard module 16 when the display module 12 is both mechanically engaged and mechanically disengaged with the keyboard module 16. It is to be understood that, in non-limiting embodiments, the display 14 is operated by the processor 50 where the processor 50 executes a full operating system when the display module 12 is mechanically disengaged with the keyboard module 16.

Further, it is to be understood that the display module 12 may not contain a processor and may only be controlled by the processor 50 on the keyboard module 16 in non-limiting embodiments. Thus, it may be appreciated that in some non-limiting embodiments, the display module 12 may not operate any operating system independent from the full operating system executed by the processor 50 on the keyboard module 16. It is to be understood that the processor 50 may execute a single operating system to control the display 14 and any other devices, equipment and/or elements on the display module 12 when the display module 12 is physically disengaged with the keyboard module 16, as well as when the display module 12 is physically engaged with the keyboard module 16.

It may be appreciated that using a single operating system controlled by one processor on the keyboard module 16 is advantageous, e.g., because a processor-less display module 12 would weigh less, not generate as much beat, and prolong battery life. The present application also limits hardware and software purchasing costs and the need for a user to learn multiple operating systems.

It is to be further understood that the keyboard module 16 may also have a display, though not shown in FIG. 4. Thus, in non-limiting embodiments, a display on the keyboard module 16 may be used simultaneously or in the alternative to the display 14 when the display module 12 is engaged with the keyboard module 16. In other words, when the display module 12 is engaged with the keyboard module 16, the display 14 and a display on the keyboard module may both be activated, or only one of the displays may be activated.

Continuing in reference to FIG. 4, in non-limiting embodiments, the processor 50 may optionally control the camera 20 and other devices, equipment and/or elements on the display module 12 both when the display module 12 is mechanically engaged and mechanically disengaged with the keyboard module 16. Thus, the camera 20 may send image signals through the transceiver 56 of the display module 12 to the transceiver 54 of the keyboard module 16 to be received by the processor 50.

Additionally, the display module 12 may include a battery 58 to power the display module 12 regardless of whether the display module 12 is physically engaged or disengaged with the keyboard module 16 in non-limiting embodiments. The keyboard module 16 may also have a battery 60 to power the keyboard module 16. However, it is to be understood that both the display module 12 and keyboard module 16 may be powered by other means, such as an electrical connection to a wall-mounted electrical outlet, a kinetic energy storage module, and/or a light-collecting power source in non-limiting embodiments.

If desired, the keyboard module 16 may also include an engagement sensor 62. The engagement sensor 62 inputs signals to the processor 50 such that the processor 50 causes at least one of the transceiver 54 and the transceiver 56 to operate in a low power mode responsive to the signals indicating the display module is physically engaged with the keyboard module. Based at least in part on signals received from the engagement sensor 62, the processor may also cause at least one of the transceiver 54 and the transceiver 56 to operate in a higher power mode responsive to the signals indicating the display module is physically disengaged with the keyboard module.

Further, in non-limiting embodiments, the engagement sensor 62 inputs signals to the processor 50 such that the processor 50 responds to signals from the display 14 responsive to the signals from the sensor 62 indicating the display module 12 is physically disengaged with the keyboard module 16. Additionally, the processor 50 may not respond to signals from the display 14 responsive to the signals from the sensor 62 indicating the display module 12 is physically engaged with the keyboard module 16, and only responding to signals from the keyboard 46 when the display module 12 is physically engaged with the keyboard module 16.

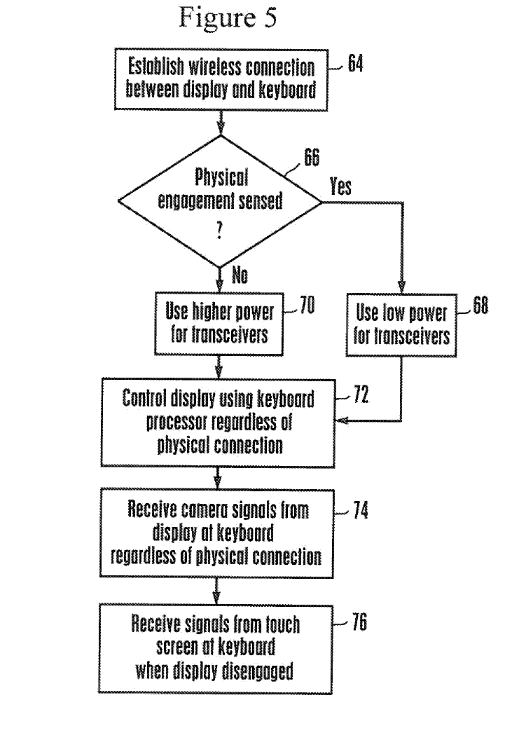

Moving on to FIG. 5, a flow chart showing example logic in accordance with present principles is shown. Beginning at block 64, the logic establishes a wireless connection between a keyboard module of a computer and a display module of the computer. It is to be understood that the keyboard module and display module described in reference to FIG. 5 may be detachably engageable with each other in accordance with present principles and may be substantially similar in function and configuration to the computers described in FIGS. 1 through 4 above.

The logic then moves from block 64 to decision diamond 66, where the logic determines whether a physical engagement between the keyboard module and display module is sensed. If the logic determines at diamond 66 that a physical engagement between the keyboard module and display module is sensed, the logic moves to block 68. At block 68, a relatively low power configuration may be used to power wireless transceivers on the keyboard module and display module that may wirelessly communicate with each other in accordance with present principles.

However, if the logic determines at diamond 66 that no physical engagement is sensed, e.g. if they keyboard module and display module are disengaged with each other, the logic instead moves from diamond 66 directly to block 70. At block 70, a relatively high power configuration may be used to power the wireless transceivers. It is to be understood that it may be advantageous to power the wireless transceivers with relatively low power when the keyboard module and display module are engaged with each other. For instance, powering the transceivers with relatively low power conserves energy and reduces heat produced by the transceivers.

After either block 68 or block 70, the logic of FIG. 5 then proceeds to block 72, where the logic controls a touch sensitive display on the display module using a keyboard processor on the keyboard module regardless of there being a physical connection between the keyboard module and the display module. The logic may then continue to block 74, where the logic may receive signals from a camera that may be movably mounted on the display module regardless of there being a physical connection between the keyboard module and the display module. The logic may then conclude at block 76, where the logic may receive signals from the display at the keyboard module only when the keyboard module is physically disengaged with the display module.

However, it is to be understood that, in other non-limiting embodiments, the logic may instead receive signals from the display at the keyboard module regardless of there being a physical connection between the keyboard module and the display module. It is to be further understood that, in some non-limiting embodiments, the logic may also receive signals from a key entry device (such as, e.g., a keyboard) on the keyboard module to control the display at the keyboard module, display images and/or present data on the display corresponding to signals from the key entry device regardless of there being a physical connection between the keyboard module and the display module.

While the particular COMPUTER WITH REMOVABLE DISPLAY MODULE FOR CONVERSION TO SLATE-TYPE COMPUTER WHILE BEING WIRELESSLY CONTROLLED BY PROCESSOR IN DETACHED KEYBOARD MODULE is herein shown and described in detail, it is to be understood that the subject matter which is encompassed by the present invention is limited only by the claims.

What is claimed is:

1. Computer comprising:
a keyboard module bearing a key entry device;
a processor in the keyboard module receiving user input signals from the key entry device;
a keyboard transceiver in the keyboard module and electrically connected to the keyboard processor;
a display module bearing a touch sensitive display, the display module being detachably engageable with the keyboard module;
a display transceiver electrically connected to the touch sensitive display and wirelessly communicating with the keyboard transceiver when the display module is physically engaged with the keyboard module, the display transceiver also wirelessly communicating with the keyboard transceiver when the display module is physically disengaged with the keyboard module;
at least one male engagement element on a first one of the modules and configured to releasably engage at least one female engagement element on a second one of the modules such that a user can manually engage and disengage the modules physically with each other; wherein
the touch sensitive display is controlled by the processor on the keyboard module when the display module is engaged and disengaged with the keyboard module.

2. The computer of claim 1, further comprising an engagement sensor inputting signals to the processor, the processor causing at least one transceiver to operate in a low power mode responsive to the signals indicating the display module is physically engaged with the keyboard module, the processor causing at least one transceiver to operate in a higher power mode responsive to the signals indicating the display module is physically disengaged with the keyboard module.

3. The computer of claim 1, further comprising an engagement sensor inputting signals to the processor, the processor responding to signals from the touch sensitive display responsive to the signals indicating the display module is physically disengaged with the keyboard module, the processor not responding to signals from the touch sensitive display responsive to the signals indicating the display module is physically engaged with the keyboard module and only responding to signals from the key entry device.

4. The computer of claim 1, wherein no processor is contained in the display module.

5. The computer of claim 1, further comprising a camera movably mounted on the display module and sending image signals through the display transceiver and keyboard transceiver to the processor.

6. The computer of claim 1, wherein the transceivers are not wireless telephony transceivers.

7. The computer of claim 1, further comprising a display battery in the display module and a keyboard battery in the keyboard module.

8. The computer of claim 1, wherein the touch sensitive display is operated by the processor executing a full operating system when the display module is physically disengaged with the keyboard module.

9. The computer of claim 1, wherein the processor executes a single operating system to control the touch sensitive display when the display module is physically disengaged with the keyboard module and when the display module is physically engaged with the keyboard module.

10. A method, comprising:
establishing a wireless connection between a keyboard module of a computer and a display module of the computer, wherein the keyboard module and display module are detachably engageable with each other; and
controlling a touch sensitive display on the display module using a keyboard processor on the keyboard module regardless of whether a mechanical connection exists between the keyboard module and the display module.

11. The method of claim 10, wherein the method further includes receiving signals from the display at the keyboard module regardless of there being a physical connection between the keyboard module and the display module.

12. The method of claim 10, wherein the method further includes receiving signals from the touch sensitive display at the keyboard module only when the display module is physically disengaged from the keyboard module.

13. The method of claim 10, wherein the method further includes receiving signals from a key entry device on the keyboard module to control the display at the keyboard module regardless of there being a physical connection between the keyboard module and the display module.

14. The method of claim 13, wherein the method further includes displaying data corresponding to signals input from the key entry device on the display regardless of there being a physical connection between the keyboard module and the display module.

15. The method of claim 10, wherein transceivers on the keyboard module and display module facilitate the wireless connection, and wherein the transceivers use a low power configuration when the keyboard module and display module are engaged with each other and a high power configuration when the keyboard module and display module are disengaged from each other.

16. A system, comprising:
a computer, including a keyboard module bearing a key entry device and a display module bearing a touch sensitive display;
a processor in the keyboard module for receiving user input signals from the key entry device;
wherein the display module is detachably engageable with the keyboard module;
wherein the display module and the keyboard module wirelessly communicate with each other when the display module is physically engaged with the keyboard module;
wherein the display module and keyboard module also wirelessly communicate with each other when the display module is physically disengaged with the keyboard module; and
wherein the touch sensitive display is controlled by the processor on the keyboard module when the display module is either engaged or disengaged with the keyboard module.

17. The system of claim 16, wherein at least one male engagement element on a first one of the modules is configured to releasably engage at least one female engagement element on a second one of the modules such that a user can manually engage and disengage the modules physically with each other

18. The system of claim 16, wherein no processor is contained in the display module.

19. The system of claim 16, wherein the touch sensitive display is operated by the processor executing a full operating system when the display module is physically disengaged with the keyboard module.

20. The system of claim 16, wherein the processor executes a single operating system to control the touch sensitive display when the display module is physically disengaged with the keyboard module and when the display module is physically engaged with the keyboard module.
